(19) United States
(12) Patent Application Publication
(10) Pub. No.: US 2011/0000215 A1
(43) Pub. Date: Jan. 6, 2011

(54) Combustor Can Flow Conditioner

(75) Inventors: Benjamin Lacy, Greer, SC (US); Thomas Johnson, Greer, SC (US); Christian Stevenson, Inman, SC (US); William York, Greer, SC (US); Baifang Zuo, Simpsonville, SC (US)

Correspondence Address: SUTHERLAND ASBILL & BRENNAN LLP, 999 PEACHTREE STREET, N.E., ATLANTA, GA, 30309, US

(73) Assignee: General Electric Company, Schnectady, NY (US)

(21) Appl. No.: 12/495,951

(22) Filed: Jul. 1, 2009

(51) Int. Cl. F02C 7/22; F02G 3/00

(52) U.S. Cl. 60/746; 60/754

(57) ABSTRACT

The present application provides a combustor for a gas turbine engine. The combustor may include a combustor can with a number of nozzles therein and a flow conditioner positioned around the combustor can. The flow conditioner may include a number of apertures therein.

### FEDERAL RESEARCH STATEMENT

This invention was made with government support under Contract No. DE-FC26-05NT42643, awarded by the U.S. Department of Energy (“DOE”). The United States has certain rights in this invention.

### TECHNICAL FIELD

The present application relates generally to gas turbine engines and more particularly relates to a full combustor can flow conditioner so as to provide a more uniform incoming air velocity to the combustor nozzles.

### BACKGROUND OF THE INVENTION

In a gas turbine, operational efficiency increases as the temperature of the combustion gas stream increases. Higher gas stream temperatures, however, may produce higher levels of nitrogen oxide (NOₓ), an emission that is subject to both federal and state regulation in the U.S. and subject to similar types of regulation abroad. A balancing act thus exists between operating the gas turbine in an efficient temperature range while also ensuring that the output of NOₓ and other types of emissions remain below the mandated levels.

New combustion concepts are exploring the use of a number of very small nozzles in the combustor. These small nozzles or other types of combustion nozzles may utilize more of the combustor cap space so as to reduce emissions and also to permit the use of highly reactive types of syngas and other fuels. To minimize the emissions and the potential for flashback with the alternative fuels, it may be desirable to have as uniform an airflow velocity distribution about the nozzles as possible. Current combustion designs, however, generally result in a non-uniform air velocity profile upstream of the combustion zone.

There is thus a desire to provide a uniform airflow velocity distribution about the combustor and the combustor cap. Preferably such a uniform airflow should provide both reduced emissions as well as improving the overall performance of the gas turbine engine.

### SUMMARY OF THE INVENTION

The present application thus provides a combustor for a gas turbine engine. The combustor may include a combustor can with a number of nozzles therein and a flow conditioner positioned around the combustor can. The flow conditioner may include a number of apertures therein.

The present application further provides a combustor for a gas turbine engine. The combustor may include a combustor can with a number of mini-tube nozzles therein and a flow conditioner positioned around the combustor can. The flow conditioner may include a cylinder with a number of apertures therein.

The present application further provides a combustor for a gas turbine engine. The combustor may include a combustor can with a number of mini-tube nozzles therein and a flow conditioner positioned around the combustor can. The flow conditioner may include a plate with a number of apertures therein.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a side cross-sectional view of a gas turbine engine that may be used with the flow conditioner described herein.

FIG. 2 is a side cross-sectional view of a combustor can with a number of bundled multi-tube injection nozzles as may be used with the flow conditioner described herein and the gas turbine engine of FIG. 1 and otherwise.

FIG. 3 is a side cross-sectional view of a full can flow conditioner as is described herein.

FIG. 4 is a side cross-sectional view of an alternative embodiment of a full can flow conditioner as may be described herein.

FIG. 5 is a plan view of a portion of an alternative embodiment of a full can flow conditioner as may be described herein.

### DETAILED DESCRIPTION

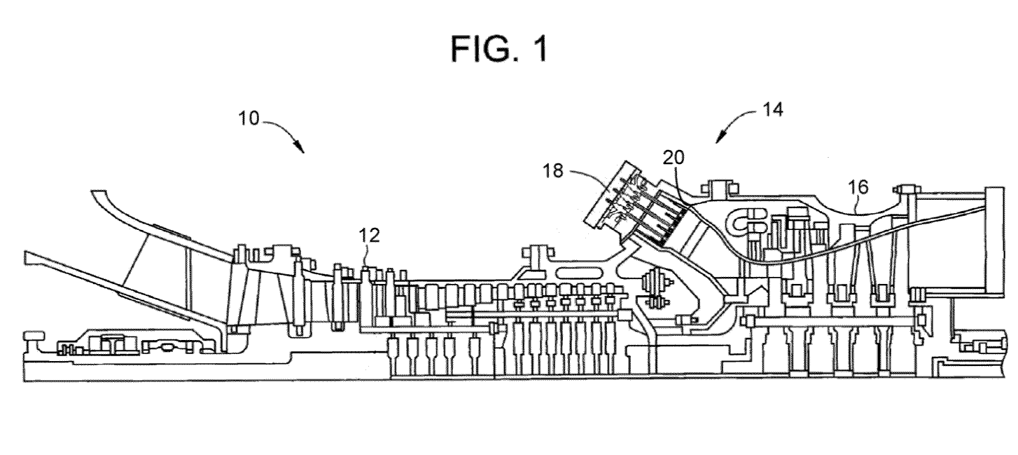

Referring now to the drawings, in which like numbers refer to like elements throughout the several views, FIG. 1 shows a side cross-sectional view of a gas turbine engine 10. As is known, the gas turbine engine 10 may include a compressor 12 to compress an incoming flow of air. The compressor 12 delivers the compressed flow of air to a combustor 14. The combustor 14 mixes the compressed flow of air with a compressed flow of fuel and ignites the mixture. (Although only a single combustor 14 is shown, the gas turbine engine 10 may include a number of combustors 14.) The hot combustion gases are in turn delivered to a turbine 16. The hot combustion gases drive the turbine 16 so as to produce mechanical work. The mechanical work produced in the turbine 16 drives the compressor 12 and an external load such as an electrical generator and the like.

The gas turbine engine 10 may use natural gas, various other types of syngas, and other types of fuels. The gas turbine engine may be a 9FBA heavy duty gas turbine engine offered by General Electric Company of Schenectady, N.Y. The gas turbine engine 10 may have other configurations and may use other types of components. Other types of gas turbine engines may be used herein. Multiple gas turbine engines 10, other types of turbines, and other types of power generation equipment may be used herein together.

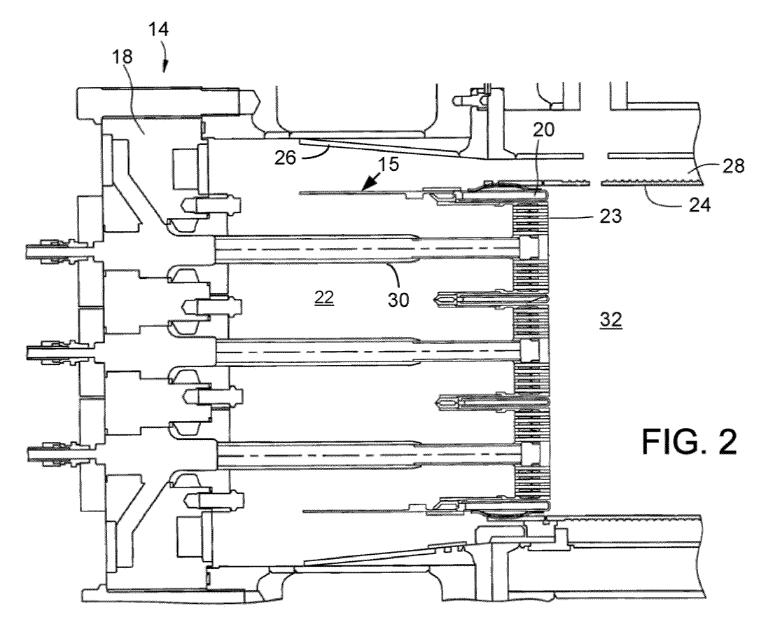

FIG. 2 shows a side cross-sectional view of an example of a combustor 14 that may be used herein. The combustor 14 includes a combustor can 15 that extends from an end cover 18 positioned at a first end thereof to a cap member 20 at the opposite end thereof. The cap member 20 is spaced from the end cover 18 so as to define an interior flow path 22 for a flow of the compressed air through the combustor can 15. The cap member 20 may define a number of mini-tube nozzles 23 therethrough. The combustor 14 further includes a combustor liner 24 and a flow sleeve 26 positioned upstream of the combustor can 15. The combustion liner 24 and the flow sleeve 26 may define a cooling flow path 28 therethrough in reverse flow communication with the interior flow path 22.

Air from the compressor 12 thus flows through the cooling flow path 28 between the combustion liner 24 and the flow sleeve 26 and then reverses into the combustor can 15. The air then flows through the interior flow path 22 defined between the end cover 18 and the cap member 20. As the air passes through mini-tube nozzles 23 of the cap member 20, the air is mixed with a flow of fuel from a fuel path 30 and is ignited within a combustion chamber 32. The combustor 14 shown herein is by way of example only. Many other types of combustor 14 designs and combustion methods may be used herein.

As the airflow approaches the nozzles 23 of the cap member 20 through the interior flow path 22, there may be a large velocity distribution variance across the cap member 20. These variances may be particularly an issue given the use of a large number of the small mini-tube nozzles 23 as opposed to the use of a few larger nozzles. Such velocity variances may impact on emission levels and other types of combustion dynamics.

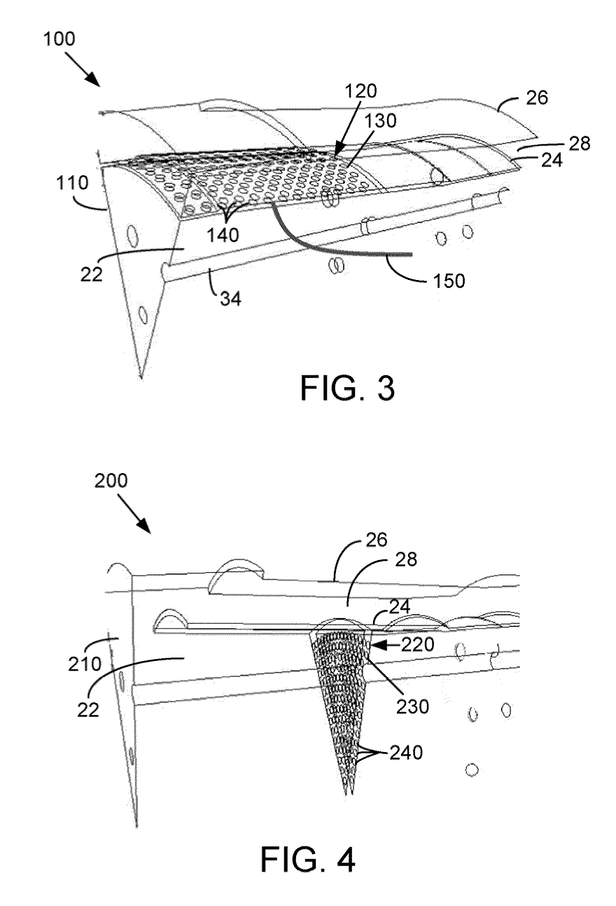

FIG. 3 shows a side cross-sectional view of a combustor 100 as may be described herein. The combustor 100 may include a combustor can 110 similar to that described above. Positioned around the combustor can 110 may be a flow conditioner 120. The flow conditioner 120 may be a perforated or a porous cylinder 130 or other types of structures. The cylinder 130 may include a number of apertures 140 extending therethrough. The number, size, and position of the apertures 140 may vary so as to optimize performance. Likewise, any shape (circle, slot, ellipse, tear drop, etc.) may be used herein. The cylinder 130 may have multiple layers. A guide vane 150 also may be used.

The flow conditioner 110 may be mounted off the end cover 18, off of the flow sleeve 26, or otherwise positioned upstream of the interior flow path 22. Mounting via the end cover 18 may provide for ease of fit or mounting via the flow sleeve 26 may provide for ease of construction. Air advancing along the cooling flow path 28 may pass through the apertures 140 of the cylinder 130 and into the interior flow path 22 towards the mini-tube nozzles 23 of the cap member 20. Forcing tile airflow through the number of apertures 140 provides a more uniform velocity through the flow conditioner 120. The use of the flow conditioner 120 thus may provide air flow with a more uniform velocity to the nozzles 23 of the cap member 20. The shape of the flow conditioner 10 and the apertures 140 also may be optimized to provide a diffuser effect to enhance pressure recovery of the air as it exits the flow sleeve 26.

FIG. 4 shows a further combustor 200 as may be described herein. The combustor 200 also may include a combustor can 210 similar to that described above. The combustor 200 may include a flow conditioner 220 positioned about the combustor can 210. In this case, the flow conditioner 220 may be in the form of a porous or a perforated plate 230 or other types of structures. The plate 230 may include a number of apertures 240 positioned therethrough. The number and size of the apertures 240 may be varied so as to enhance performance therethrough. Likewise, any shape (circle, slot, ellipse, tear drop, etc.) may be used herein. The plate 230 may have multiple layers. The plate 230 may be positioned just upstream of the internal flow path 22 or within the internal flow path 22 upstream of the cap member 20. The plate 230 may be attached to a fuel line 34, attached to the end cover 18 via struts and the like, or otherwise fixed. Air advancing along the cooling flow path 28 may pass into the interior flow path 22 and through the apertures 240 of the plate 230 towards the mini-tube nozzles 23 of the cap member 20.

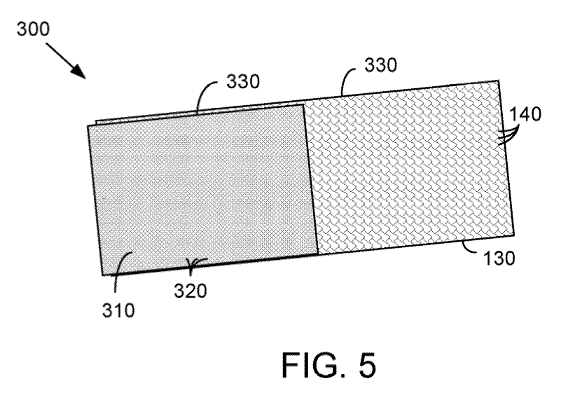

FIG. 5 shows a further flow conditioner 300 positioned the combustor can 110,210. In this case, the flow conditioner 300 may be in the form of a screen or a mesh 310 defining a number of apertures 320 therethrough. The number and size of the apertures 320 may be varied so as to enhance performance therethrough. Likewise, any shape (circle, slot, ellipse, tear drop, etc.) may be used herein. The flow conditioner 300 may have one or more layers 330. As is shown, he screen or mesh 310 also may be layered in whole or in part with the cylinder 130 or the plate 230 as part of the overall flow conditioner 110, 210. Air advancing along the cooling flow path 28 may pass through the screens/mesh 310 and/or multiple layers of the cylinder 130 and/or the plate 210 and into the interior flow path 22 towards the mini-tube nozzles 23 of the cap member 20.

The use of the flow conditioners 120, 220, 300 as a cylinder 130, a plate 230, or a screen/mesh 310 is by way of example only. Many other configurations may be used to reduce the velocity variances in the airflow and otherwise normalize the airflow as it enters the nozzles 23. Likewise, a diffuser effect may enhance the pressure recovery of the air as it exits the flow sleeve 26.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A combustor for a gas turbine engine, comprising:
a combustor can;
the combustor can comprises a plurality of nozzles therein; and
a flow conditioner positioned around the combustor can;
the flow conditioner comprises a plurality of apertures therein.

2. The combustor of claim 1, wherein the combustor can comprises an end cover and a cap member.

3. The combustor of claim 2, wherein the end cover and the cap member define an interior flow path and wherein the flow conditioner is positioned upstream of the interior flow path.

4. The combustor of claim 2, wherein the end cover and the cap member define an interior flow path and wherein the flow conditioner is positioned within the interior flow path.

5. The combustor of claim 2, wherein the flow conditioner is attached to the end cover.

6. The combustor of claim 1, wherein the plurality of nozzles comprises a plurality of mini-tube nozzles.

7. The combustor of claim 1, further comprising a flow sleeve and wherein the flow conditioner is attached to the flow sleeve.

8. The combustor of claim 1, wherein the flow conditioner comprises a cylinder.

9. The combustor of claim 1, wherein the flow conditioner comprises a plate.

10. The combustor of claim 1, wherein the flow conditioner comprises a screen or a mesh.

11. The combustor of claim 1, wherein the flow conditioner comprises a plurality of layers.

12. A combustor for a gas turbine engine, comprising:
a combustor can;
the combustor can comprises a plurality of mini-tube nozzles therein; and
a flow conditioner positioned around the combustor can;
the flow conditioner comprises a cylinder with a plurality of apertures therein.

13. The combustor of claim 12, wherein the combustor can comprises an end cover and a cap member defining an interior flow path and wherein the flow conditioner is positioned upstream of the interior flow path.

14. The combustor of claim 12, wherein the flow conditioner comprises a screen or a mesh.

15. The combustor of claim 12, wherein the flow conditioner comprises a plurality of layers.

16. A combustor for a gas turbine engine, comprising:
a combustor can;
the combustor can comprises a plurality of mini-tube nozzles therein; and
a flow conditioner positioned around the combustor can;
the flow conditioner comprises a plate with a plurality of apertures therein.

17. The combustor of claim 16, wherein the combustor can comprises an end cover and a cap member.

18. The combustor of claim 17, wherein the end cover and the cap member define an interior flow path and wherein the flow conditioner is positioned upstream of the interior flow path.

19. The combustor of claim 17, wherein the end cover and the cap member define an interior flow path and wherein the flow conditioner is positioned within the interior flow path.

20. The combustor of claim 16, wherein the combustor can comprises a fuel line extending therethrough and wherein the plate is attached to the fuel line.

21. The combustor of claim 16, wherein the flow conditioner comprises a screen or a mesh.

22. The combustor of claim 16, wherein the flow conditioner comprises a plurality of layers.
